(19) United States
(12) Patent Application Publication
(10) Pub. No.: US 2021/0313595 A1
(43) Pub. Date: Oct. 7, 2021

(54) ELECTRODE SUPPORT DEVICE FOR SUPPORTING AN ELECTRODE UNIT

(71) Applicant: Robert Bosch GmbH, Stuttgart (DE)

(72) Inventors: Andreas Haeffelin, Vaihingen (DE); Friedrich Kneule, Rutesheim (DE)

(21) Appl. No.: 17/264,625

(22) PCT Filed: Sep. 18, 2019
(86) PCT No.: PCT/EP2019/074974

§ 371 Date: Jan. 29, 2021

(30) Foreign Application Priority Data
Sep. 21, 2018 (DE) 10 2018 216 100.3

(51) Int. Cl. H01M 8/0271; C25B 1/04; C25B 9/19; C25B 9/63

(52) U.S. Cl. CPC H01M 8/0271; C25B 1/04; H01M 2008/1293; C25B 9/63; C25B 9/19

(57) ABSTRACT

An electrode support device for supporting an electrode unit of a fuel cell unit and/or electrolyzer unit, in particular of a solid oxide fuel cell unit. The electrode support device includes at least one electrode installation surface for the electrode unit, and at least one form-fitting unit situated at the electrode installation surface for fixing the electrode unit at the electrode installation surface.

### BACKGROUND INFORMATION

An electrode support device has already been provided for supporting an electrode unit of a fuel cell unit and/or an electrolyzer unit, in particular, a solid oxide fuel cell unit, including at least one electrode installation surface for the electrode unit.

### SUMMARY

The present invention is directed to an electrode support device for supporting an electrode unit of a fuel cell unit and/or electrolyzer unit, in particular, a sold oxide fuel cell unit, including at least one electrode installation surface for the electrode unit.

In accordance with an example embodiment of the present invention, it is provided that the electrode support device includes at least one form-fitting unit situated at the electrode installation surface for fixing the electrode unit at the electrode installation surface. A “fuel cell unit and/or electrolyzer unit” in this context is/are understood to mean, in particular at least a part, in particular a subassembly of a fuel cell, in particular of a solid oxide fuel cell, and/or of an electrolyzer, in particular a high temperature electrolyzer. The fuel cell unit and/or electrolyzer unit may in particular, also include the entire fuel cell, in particular the entire solid oxide fuel cell, the entire electrolyzer, in particular the entire high temperature electrolyzer, a stack made up of fuel cells and/or electrolyzers and/or a combination of multiple stacks made up of fuel cells and/or electrolyzers. The fuel cell unit and/or electrolyzer unit is/are preferably provided to combust a fuel while adding an oxidant in a combustion process to produce electrical energy. Alternatively or in addition, the fuel cell unit and/or electrolyzer unit is/are provided to split a fluid into at least two components while adding electrical energy in a separation process. “Provided” is understood to mean, in particular, specifically configured, specifically designed and/or specifically equipped. That an object is provided for a particular function is understood to mean, in particular, that the object fulfills and/or carries out this particular function in at least one application state and/or operating state.

An “electrode unit” of a fuel cell unit and/or electrolyzer unit is preferably understood to mean a unit that includes at least one electrode, in particular an electrode layer, which is directly involved in the combustion process and/or separation process carried out with the aid of the fuel cell unit and/or electrolyzer unit. The electrode unit preferably includes in particular, in addition to the electrode, at least one further electrode, in particular one further electrode layer. The electrode and the further electrode are provided, in particular for use as a cathode-anode pair. The electrode unit preferably includes at least one separating element, in particular an electrolyte layer. The separating element is situated preferably between the electrode and the further electrode. The electrode and/or the further electrode is/are designed as an oxidant electrode, in particular, for a contact with the oxidant and/or with a cleavage product. At least the electrode and/or the further electrode is/are designed as a fuel electrode, in particular, for a contact with the fuel and/or with a further cleavage product. The electrode unit is designed, in particular, as a membrane electrode assembly (MEA).

The electrode support device is preferably provided for a mechanical and/or thermal stabilization of the electrode unit. A maximum extension of the electrode installation surface is preferably greater than a maximum extension of the electrode unit. In particular, a maximum size of the electrode installation surface is, greater than a maximum size of the electrode unit. The electrode support device preferably has a maximum extension at least in a direction perpendicular to the electrode installation surface, which is greater, preferably more than twice as great, particularly preferably more than five times greater, than a maximum extension of the electrode unit in a direction perpendicular to the electrode installation surface, in a state of the electrode unit situated, in particular fixed, on the electrode support device.

In accordance with an example embodiment of the present invention, the electrode support device preferably includes at least one base body. The electrode installation surface is preferably designed at least as a subarea of a surface, in particular of a largest outer surface of the base body. The electrode support device, in particular the base body, is flat. The electrode support device, in particular the base body has a maximum extension, at least in a direction perpendicular to the electrode installation surface, in particular perpendicular to the largest outer surface, which is less than a maximum extension, preferably less than 1/10 of a maximum extension, particularly preferably less than 1/30 of a maximum extension, of the electrode installation surface. A largest curvature radius of a curvature of the largest outer surface, in particular of the electrode installation surface, in particular, at least in a reference state of the electrode support device, is larger than, in particular more than three times as large as, particularly preferably more than five times as large as, the maximum extent of the largest outer surface, in particular of the electrode installation surface. The base body is designed preferably as a film, as a disk, as a fabric, as a plate or the like. The maximum extension of the electrode support device in particular, of the base body in particular, is at least less than 1 mm, preferably less than 750 μm, particularly preferably less than 500 μm, in the direction perpendicular to the electrode installation surface, in particular to the largest outer surface.

The electrode support device, in particular the base body, is manufactured at least essentially from at least one metal. That an object is manufactured “essentially from one material” is understood to mean, in particular, that a volume portion of the material is more than 25%, preferably more than 50%, particularly preferably more than 75%, of a total volume of the object. Alternatively, the electrode support device, in particular the base body, is manufactured at least essentially from a ceramic and/or a plastic. The electrode support device is preferably manufactured at least essentially from a high temperature stable material, in particular metal. “High temperature stable” is understood to mean, in particular, dimensionally stable and/or chemically stable up to temperatures of at least 500° C., preferably up to temperatures of at least 850° C., in particular preferably up to temperatures of at least 1200° C. It is possible that the electrode support device includes components, which are manufactured from a ceramic, a plastic or another material for example, for an electrical and/or thermally insulating fixing of the electrode support device and/or of individual components of the electrode support.

The form-fitting unit, in particular at least a form-fitting element of the form-fitting unit, is preferably provided to establish a form-fitting or a form-fitting and force-fitting connection with the electrode unit, in particular with a form-fitting element of the electrode unit complementary to the form-fitting element. The form-fitting unit is provided, in particular, to additionally secure a present force-fitting and/or materially integral connection of the electrode support device with the electrode unit. The form-fitting unit is preferably provided to establish a form-fitting or a form-fitting and force-fitting connection between the electrode support device and the electrode unit in a direction essentially parallel to the electrode installation surface. “Essentially parallel” is understood here to mean, in particular, an orientation of a direction relative to a reference direction, in particular in one plane, the direction exhibiting a deviation in particular of less than 8°, advantageously less than 5°, and particularly advantageously less than 2°, compared to the reference direction. The form-fitting unit preferably includes at least one form-fitting element, preferably a multitude of form-fitting elements. For example, the form-fitting unit includes a form-fitting element shaped as a nub, as a web, as a hook, as a pin, as a groove, as a cone, as an eye, as a lamella, as a bulge, as an enclosure, as a notch, as a collar or the like. At least two form-fitting elements, preferably at least a plurality of form-fitting elements, are at least essentially identically constructed. “Essentially identically constructed” is understood to mean, in particular, except for manufacturing tolerances. It is also possible, however, that the form-fitting unit includes at least two differently designed form-fitting elements. At least one form-fitting element, preferably a plurality of the form-fitting elements, of the form-fitting unit, is preferably situated at the electrode installation surface. At least one form-fitting element, preferably a plurality of the form-fitting elements, of the form-fitting unit, is fixed on the base body of the electrode support device.

With the aid of the embodiment of the electrode support device according to the present invention, it is possible to achieve an advantageously secure fixing of the electrode unit on the electrode support device. It is possible, in particular, to additionally secure a force-fitting and/or materially integral connection of the electrode unit with the electrode support device established for example, by sintering. The electrode support device may, in particular, be advantageously rapidly tempered, in particular heated, in a state connected to the electrode unit in a form-fitting manner. A detachment, in particular a delamination of the electrode unit from the electrode support device during a, in particular, rapid tempering, may in particular be advantageously prevented.

It is further provided that at least one form-fitting element of the form-fitting unit is designed as one piece with the electrode installation surface. The form-fitting unit is preferably designed at least partially, preferably at least essentially, as one piece with the electrode installation surface, in particular with the base body of the electrode support device. “As one piece” is understood to mean, in particular at least materially integrally joined, for example, via a welding process, a bonding process, an overmolding process and/or another process appearing meaningful to those skilled in the art, and/or advantageously formed in one piece, as for example, by manufacturing from a casting and/or by manufacturing in a single-component or multi-component injection molding method and advantageously from a single blank. At least one form-fitting element is advantageously designed as a manufactured element of a, in particular selective, material removal process from the electrode installation surface, for example, of a cutting process, of a machining process, of an etching process or the like. Alternatively or in addition, at least one form-fitting element is designed as a manufactured element of a material application process at the electrode installation surface, for example, of a welding process, a bonding process, an overmolding process or the like. It is also possible that the form-fitting unit is designed as a layer, which is applied on the electrode installation surface. That the form-fitting unit is designed “essentially as one piece” with an object is understood to mean, in particular, that at least a plurality of the form-fitting elements, preferably all form-fitting elements, of the form-fitting unit are designed as one piece with the object. It is possible that the form-fitting unit includes at least one component, in particular a form-fitting element, for example, a locking element, a screw element, a plug element, a closure element or the like, which is independently designed. As a result of the embodiment according to the present invention, the electrode support device includes advantageously few individual parts. An application of the electrode unit on the electrode support device, in particular a fixing with the form-fitting unit, may, in particular, be carried out in an advantageously simple manner.

It is further provided that at least one form-fitting element of the form-fitting unit is situated in a fluid channel-free subarea of the electrode installation surface. The electrode support device preferably includes at least one fluid channel. The electrode support device preferably includes a multitude of, in particular at least essentially identically constructed fluid channels. At least one fluid channel of the electrode support device is preferably set into the base body of the electrode support device. An outlet opening of at least one fluid channel of the electrode support device is situated preferably at the electrode installation surface. The electrode installation surface preferably completely surrounds the outlet opening of the at least one fluid channel. The electrode installation surface preferably includes at least one fluid channel area. The outlet opening of the at least one fluid channel is preferably situated in the fluid channel area. The fluid channel area preferably completely surrounds the outlet opening of the at least one fluid channel. The plurality of the outlet openings and/or all outlet openings of all fluid channels is/are preferably situated apart from one another at regular and/or irregular intervals. The fluid channel area is designed preferably in a cohesive manner. It is also possible that the electrode installation surface includes multiple fluid channel areas, which are situated spaced apart from one another. A “fluid channel-free subarea” is understood, in particular, to mean a subarea of the electrode installation surface, in which each point belonging to the section includes at least one minimum distance to the outlet opening of a fluid channel, in particular of all fluid channels. The minimum distance is preferably greater than a maximum extent of the, in particular largest outlet opening. The minimum distance is preferably greater than a minimum and/or maximum distance between two, in particular adjacent, outlet openings. The fluid channel area is at least essentially completely enclosed by the fluid channel-free subarea and/or by multiple fluid channel-free subareas. “Essentially completely enclosed” is understood in this context to mean, in particular, that at least one, in particular, the fluid-free subarea abuts at least 50%, preferably more than 75%, particularly preferably more than 95%, of a maximum size of the fluid channel area. The fluid channel area is, in particular, situated spaced apart from an outer boundary of the electrode installation surface. The fluid channel-free subarea forms, in particular, a border area between the fluid channels and the outer boundary of the electrode installation surface. The fluid channel-free subarea is provided, in particular for installing, in particular for fixing, the separating element of the electrode unit. At least one form-fitting element, preferably multiple form-fitting elements, is/are situated in the fluid channel-free subarea. At least one form-fitting element is preferably situated at least on a significant portion of the fluid-channel free subarea. “A significant portion” of an area is preferably understood to mean, at least 10%, preferably at least 30%, particularly preferably more than 50%, of a surface area of the area. With the aid of the embodiment according to the present invention, it is possible to advantageously secure a fluidic seal of the fluid channel area of the electrode installation surface via the electrode unit.

It is further provided that at least one form-fitting element of the form-fitting unit is situated in a fluid channel area of the electrode installation surface. At least one form-fitting element is situated, in particular, between at least two fluid channels. At least one form-fitting element is preferably situated at least on a significant portion of the fluid channel area. It is possible that differently shaped and/or at least essentially identically constructed form-fitting elements are situated in the fluid channel area and in the fluid channel-free subarea. It is possible that the at least one form-fitting element is designed in an undercut-free manner, in particular, to enable a cost-efficient manufacturing of the form-fitting element. At least one form-fitting element is preferably situated at least on a significant portion of the entire electrode installation surface. Alternatively or in addition, the fluid channel area includes at least one marked support point for attaching a form-fitting element. An, in particular, otherwise regular, arrangement of the outlet openings is, in particular, interrupted at the marked support point. The fluid channel area includes, in particular, multiple marked support points at regular and/or irregular intervals to one another. With the aid of the embodiment according to the present invention, it is possible to advantageously fix the electrode unit securely on the electrode support device. A partial detachment of the electrode support device may, in particular, be advantageously avoided.

It is also provided that at least one form-fitting element of the form-fitting unit includes an undercut. A profile of the form-fitting element, in particular, includes an undercut in at least one sectional plane at least essentially perpendicular to the electrode installation surface. The term “essentially perpendicular” is intended here to define, in particular, an orientation of a direction relative to a reference direction, the direction and the reference direction, viewed, in particular in one plane, encompassing an angle of 90°, and the angle exhibiting a maximum deviation of, in particular less than 8°, advantageously less than 5°, and particularly advantageously less than 2°. The form-fitting unit preferably includes a sectional area in a sectional plane parallel to the electrode installation surface having a surface area that is greater than a surface area of a further sectional area in a further sectional plane parallel to the electrode installation surface, which is situated closer to a side of the electrode support device that faces away from the electrode installation surface, in particular of the base body, than the sectional plane. The form-fitting element is preferably tapered in the direction of the side that faces away from the electrode installation surface. It is also possible, however, that the form-fitting element includes a step, in particular a T-shaped profile. With the aid of the embodiment according to the present invention, it is possible to advantageously reliably shape a form-fit in a direction extending essentially in parallel to the electrode installation surface. An additional form-fit may be achieved, in particular in at least an essentially perpendicular and/or transverse direction relative to the electrode installation surface.

It is further provided that the form-fitting unit includes at least one form-fitting element designed as a microtooth for toothing with the electrode unit. A “microtooth” is understood to mean, in particular, a tooth-shaped form-fitting element, in which a smallest imagined cuboid that completely surrounds the tooth-shaped form-fitting element includes at least one, preferably two, particularly preferably three, characteristic edge lengths, which are in a micrometer range, in particular of less than 3 mm, preferably less than 500 μm, particularly preferably less than 100 μm, and/or preferably at least greater than 500 nm, and/or preferably at least greater than 1 μm. A “tooth-shaped form-fitting element” is understood to mean, in particular, a structural element, which includes at least one tooth flank, preferably two tooth flanks, in particular for forming a form-fit in a direction at least essentially perpendicular to the tooth flank. The tooth flanks are designed preferably symmetrically and/or are situated relative to a plane at least essentially perpendicular to the electrode installation surface. It is also possible that the tooth flanks are differently designed. For example, the microtooth has a rectangular, a trapezoidal, a triangular and/or a parabolic profile in a plane at least essentially perpendicular to the electrode installation surface. It is possible that the microtooth is torsionally-symmetrically and/or rotationally symmetrically designed relative to an axis of symmetry. Alternatively, the microtooth is designed as a web, in particular, a maximum extension of the web being greater than a maximum extension of the profile. The electrode unit preferably includes a further, in particular similarly and/or complementarily designed form-fitting element, in particular a further microtooth for toothing with the microtooth. With the aid of the embodiment according to the present invention, it is possible to design the form-fitting unit advantageously flat. The electrode support device may, in particular, have an advantageously compact design. A design of the electrode installation surface, in particular of the fluid channel area, is limited advantageously very little by the form-fitting unit. A provision of marked support points for an arrangement of the form-fitting unit, in particular of the form-fitting element, may in particular be dispensed with.

It is further provided that the form-fitting unit includes a multitude of form-fitting elements designed as microteeth for a toothing with the electrode unit. The microteeth are preferably situated at regular intervals to one another on the electrode installation surface. Microteeth designed as webs are situated, in particular, at least essentially parallel to one another. It is also possible that the microteeth are distributed irregularly on the electrode installation surface. It is possible, in particular, that the form-fitting unit includes at least two differently designed microteeth. Different microteeth are, in particular, situated in different subareas of the electrode installation surface, for example, in the fluid channel area and/or in the fluid channel-free area. It is also possible that the electrode installation surface includes at least two partially overlapping subareas in which the at least two different microteeth are situated. At least a significant portion of the fluid channel-free subarea, of the fluid channel area, and/or of the entire electrode installation surface is/are preferably fitted with microteeth. With the aid of the embodiment according to the present invention, it is possible to provide an advantageously large subarea of the electrode installation surface with microteeth. The form-fitting unit may, in particular, have an advantageously highly effectively active surface. An advantageously secure form-fit or form-fit and force fit between the electrode unit and the electrode support device, in particular, may be achieved.

The present invention is further directed to a method for manufacturing a fuel cell unit and/or an electrolyzer unit, in particular a solid oxide fuel cell unit, the fuel cell unit and/or the electrolyzer unit including at least one electrode unit and at least one electrode support device, in particular an electrode support device according to the present invention, for supporting the electrode unit. In accordance with an example embodiment of the present invention, it is provided that in at least one method step, the electrode unit is connected at least in a form-fitting manner to the electrode support device. The electrode support device is preferably manufactured in at least one electrode support manufacturing step. At least one base body, in particular a metal sheet, of the electrode support device is preferably structured in the electrode support manufacturing step. At least one fluid channel is, in particular, set into the base body in the electrode support manufacturing step. The at least one fluid channel is preferably set into the base body of the electrode support device by a forming process, in particular, with the aid of punching, imprinting, milling, laser drilling, laser cutting or the like.

The form-fitting unit of the electrode support device is preferably situated, in particular formed, at the electrode installation surface during the electrode support manufacturing step. The electrode unit is preferably manufactured, in particular at least pre-formed, in at least one electrode manufacturing step. At least one blank, one preform, one green body, one whiting or the like of the electrode unit is preferably manufactured in the electrode manufacturing step. The electrode unit is manufactured preferably on a transport element. The, in particular, pre-formed electrode unit is applied on the electrode support device in at least one joining step. Alternatively, the electrode unit is manufactured directly, in particular in layers, on the electrode support device. The electrode unit is preferably converted from a pre-formed state, in particular by sintering and/or by curing, into a final state in at least one method step after application on the electrode support device. The electrode unit is preferably connected in a form-fitting or form-fitting and force-fitting manner to the electrode support device in the joining step and/or during the direct manufacture on the electrode support device. The electrode unit is preferably connected to the electrode support device in at least one method step in a form-fitting or form-fitting and force-fitting manner in a direction at least essentially parallel to the electrode installation surface. The electrode unit is, in particular, connected in a pre-formed state to the electrode support device in a form-fitting or form-fitting and force-fitting manner. With the aid of the embodiment of the method according to the present invention, it is possible to achieve an advantageously secure fixing of the electrode unit on the electrode support device. It is possible, in particular, to additionally secure the force-fitting and/or materially integral connection of the electrode unit to the electrode support device established, for example, by sintering. The electrode support device may, in particular, be advantageously rapidly tempered, in particular heated, in a state connected to the electrode unit in a form-fitting manner. Processing times may, in particular, be advantageously minimized.

It is further provided that in at least one method step, at least one form-fitting element of a form-fitting unit of the electrode support device is formed at the electrode installation surface of the electrode support device, in particular by a material removal process and/or by a material application process. The form-fitting unit is manufactured preferably during the electrode support manufacturing step. The at least one form-fitting element of the form-fitting unit, in particular, is manufactured during the electrode support manufacturing step.

The form-fitting element is situated, in particular, at the electrode installation surface. The form-fitting element is, in particular, formed at the electrode installation surface. The form-fitting element is preferably formed by at least one, in particular, selective material removal process, for example, by a machining process, by a laser cutting process and/or drilling process, by an etching process or the like. In at least one method step, material is preferably removed from the base body of the electrode support device to form the form-fitting element. Material is removed, in particular, from the electrode installation surface for forming the form-fitting element. Alternatively or in addition, in at least one method step, material is applied on the base body, in particular on the electrode installation surface, in particular for forming at least one form-fitting element, for example, with the aid of a welding process, a bonding process and/or an overmolding process, preferably with the aid of an application of an additive manufacturing method. With the aid of the embodiment according to the present invention, it is possible to manufacture an advantageously compact fuel cell unit and/or electrolyzer unit.

It is further provided that in at least one method step, a shape of the electrode unit is adapted to at least one form-fitting element of a form-fitting unit of the electrode support device for an application of the electrode unit on the electrode support device. A further form-fitting element similar to or complementary to the form-fitting element is, in particular, molded on the electrode unit, in particular, on the separating element. The electrode unit, in particular in a pre-formed state, is preferably applied on the electrode installation surface. The electrode unit is, in particular, situated on the form-fitting element. In at least one method step, the electrode unit is preferably pressed onto the form-fitting element, in particular for a plastic deformation of the electrode unit by the form-fitting element. The electrode unit is, in particular, laminated onto the form-fitting element. Alternatively, the electrode unit is applied directly to the form-fitting element, for example, using a screen printing method, a spray process, a gas phase deposition process or the like. In one alternative embodiment, at least one form-fitting element of the electrode unit corresponding to the form-fitting element is at least pre-formed and/or finished prior to an application of the electrode unit on the electrode installation surface. With the aid of the embodiment according to the present invention, it is possible to shape a form-fitting element of the electrode unit corresponding to the form-fitting element in a manner advantageously complementary to the form-fitting element. The corresponding form[-fitting] element may, in particular, be advantageously manufactured accurately fitting. The corresponding form-fitting element may, in particular, be manufactured in an advantageously simple manner. A control of the manufacturing accuracy may, in particular, be dispensed with.

It is further provided that in at least one method step, a dimensioning of at least one form-fitting element of a form-fitting unit of the electrode support device is adapted to a particle size of the electrode unit. The electrode unit is preferably preformed at least from one granulate and, in particular, from a binding agent and/or a paste that includes, in particular, granules. A “particle size of the electrode unit” is understood to mean an average maximum extension of individual granules of the paste and/or of the granulate, in particular, from which the electrode unit is preformed. The form-fitting element is preferably formed in such a way that at least one, in particular, a characteristic edge length of a smallest cuboid completely surrounding the form-fitting element at least essentially perpendicular to the electrode installation surface is greater than the particle size of the electrode unit. Two directly adjacent form-fitting elements are particularly preferably manufactured at a minimum distance to one another, which is greater than the particle size of the electrode unit. With the aid of the embodiment according to the present invention, it is possible to achieve an advantageously reliable distribution of the electrode unit, in particular of the granules of the electrode unit on, around, and between the form-fitting elements. A form-fitting element of the electrode unit corresponding to the form-fitting element may, in particular, be adapted advantageously exactly to a shape of the form-fitting element. A formation of cavities may, in particular, be advantageously minimized.

It is further provided that in at least one method step, the at least one form-fitting element of the form-fitting unit of the electrode support device is created with the aid of laser texturing or with the aid of an additive manufacturing step such as, for example, with the aid of a powder bed process step, of a free space method step, of a liquid material method step or the like. The form-fitting unit, in particular the at least one form-fitting element, is manufactured preferably by a laser machining of the electrode installation surface. The electrode installation surface is, in particular, textured with the aid of laser machining. Regular and/or irregular structures are, in particular, introduced into the electrode installation surface to form form-fitting elements. Alternatively or in addition, at least one form-fitting element is shaped by an etching process and/or a machining process, in particular, a drilling process, a milling process and/or a filing process. With the aid of the embodiment according to the present invention, it is possible to implement advantageously precise, advantageously regularly situated and/or advantageously small form-fitting elements.

A fuel cell unit and/or electrolyzer unit is/are also provided, which is/are manufactured according to a method according to the present invention and/or which includes/include an electrode support device according to the present invention. The fuel cell unit and/or electrolyzer unit is/are designed preferably as a metal-supported fuel cell unit and/or electrolyzer unit. With the aid of the embodiment according to the present invention, it is possible to provide a fuel cell unit and/or electrolyzer unit, which has an advantageously secure mechanical connection of the electrode unit and the electrode support device. A fuel cell unit and/or electrolyzer unit may, in particular, be provided, which exhibits/exhibit an advantageously high tolerance to temperature gradients and/or to thermomechanical stresses. The fuel cell unit and/or electrolyzer unit may, in particular, be rapidly nondestructively tempered, in particular, heated. The fuel cell unit and/or electrolyzer unit has/have, in particular, an advantageously long service life.

The electrode support device according to the present invention, the method according to the present invention and/or the fuel cell unit and/or electrolyzer unit according to the present invention is/are not to be restricted to the application and specific embodiment described above. The electrode support device according to the present invention, the method according to the present invention and/or the fuel cell unit and/or electrolyzer unit according to the present invention may, in particular, include a number, differing from a number of individual elements, components and units, as well as method steps cited herein for fulfilling an operating mode described herein. In addition, values also lying within the cited limits in value ranges specified in this description are to be considered as described and as arbitrarily usable.

### BRIEF DESCRIPTION OF THE DRAWINGS

Further advantages result from the following description of the figures. One exemplary embodiment of the present invention is shown in the figures. The figures and the description contain numerous features in combination. Those skilled in the art will advantageously also consider the features individually and combine them to form meaningful further combinations.

FIG. 1 schematically shows a representation of a fuel cell unit and/or electrolyzer unit according to an example embodiment of the present invention.

FIG. 2 schematically shows a representation of an electrode support device according to an example embodiment of the present invention.

FIG. 3 schematically shows a representation of a form-fitting element of the electrode support device according to an example embodiment of the present invention.

FIG. 4 schematically shows a representation of a further form-fitting element of the electrode support device according to an example embodiment of the present invention,

FIG. 5 schematically shows a representation of additional form-fitting elements of the electrode support device according to an example embodiment of the present invention.

FIG. 6 schematically shows a representation of another form-fitting element of the electrode support device according to an example embodiment of the present invention.

FIG. 7 schematically shows a representation of one method according to an example embodiment of the present invention.

### DETAILED DESCRIPTION OF EXAMPLE EMBODIMENTS

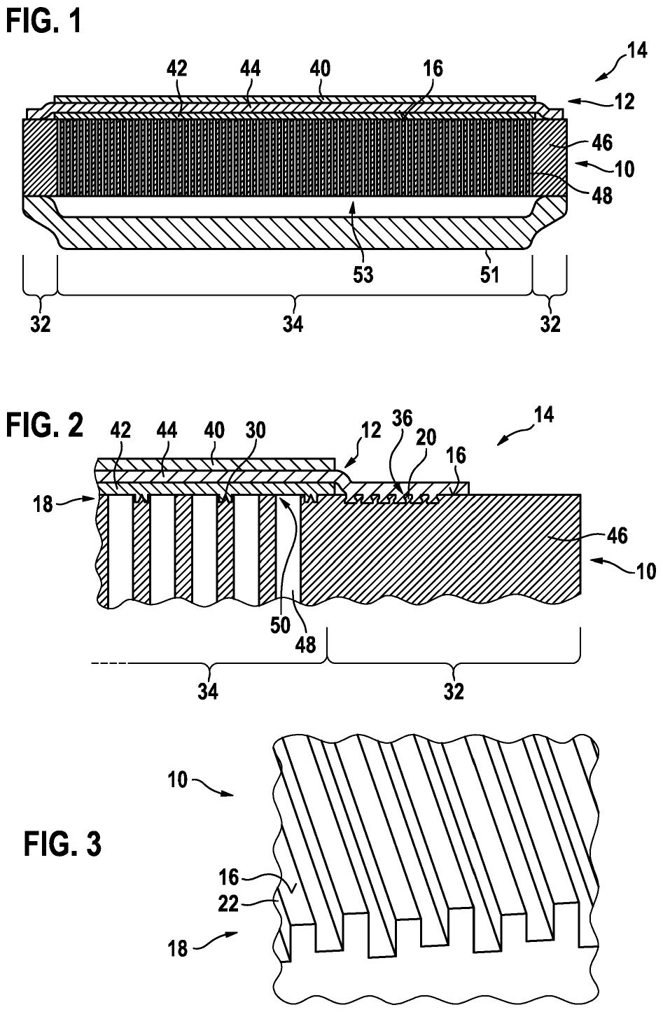

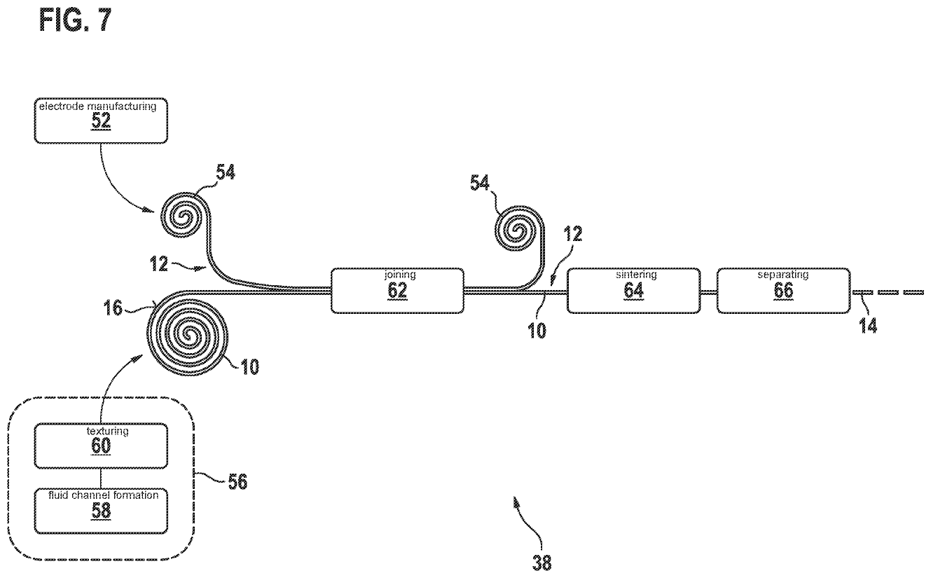

FIG. 1 shows a fuel cell unit and/or electrolyzer unit 14. Fuel cell unit and/or electrolzyer unit 14 is/are manufactured using a method 38 (see FIG. 7). Fuel cell unit and/or electrolyzer unit 14 include(s) an electrode support device 10. Fuel cell unit and/or electrolyzer unit 14 preferably include(s) at least one electrode unit 12. Fuel cell unit and/or electrolyzer unit 14 is/are preferably designed, in particular as a metal-supported solid oxide fuel cell unit. Electrode unit 12 preferably includes at least one electrode 40. Electrode unit 12 preferably includes at least one further electrode 42. Electrode 40 and/or further electrode 42 is/are each designed as an electrode layer. Electrode 40 is preferably formed from an oxidant electrode material. Further electrode 42 is preferably formed from a fuel electrode material. It is also possible, however that electrode 40 is formed from a fuel electrode material and/or further electrode 42 is formed from an oxidant electrode material. Electrode unit 12 preferably includes at least one separating element 44, in particular, a separating layer. Separating element 44 is preferably designed as an electrolyte layer. Separating layer 44 is preferably situated between electrode 40 and further electrode 42. Electrode unit 12 is preferably situated on electrode support device 10.

Electrode support device 10 is provided for supporting electrode unit 12 of fuel cell unit and/or electrolyzer unit 14. Electrode support device 10 includes at least one electrode installation surface 16 for electrode unit 12. Electrode installation surface 16, in particular, contacts electrode unit 12. Electrode support device 10 includes preferably at least one, in particular flat, base body 46. Base body 46 is designed preferably as a film, disk and/or plate, in particular as a metal sheet. Electrode support device 10 preferably includes at least one fluid channel 48. Electrode support device 10 preferably includes a multitude of further fluid channels designed, in particular, similarly to fluid channel 48 and situated, in particular, at least essentially in parallel. Fluid channel 48 is preferably set into base body 46. Fluid channel 48, in particular, penetrates base body 46. At least one outlet opening 50 of fluid channel 48 preferably empties into electrode installation surface 16. Electrode installation surface 16 preferably completely surrounds outlet opening 50 in at least one plane. Electrode installation surface 16 includes at least one fluid channel area 34. Fluid channel 48, in particular, and, in particular, all further fluid channels of electrode support device 10 are situated in fluid channel area 34. Electrode installation surface 16 preferably includes one fluid channel-free subarea 32. Further electrode unit 12 preferably contacts fluid channel area 34. Separating element 44 preferably contacts fluid channel-free subarea 32. Fluid channel-free subarea 32, in particular, encloses fluid channel area 34 completely at least in one plane. Separating element 44, in particular, seals fluid channel area 34 off from fluid channel-free subarea 32 and/or from electrode 40 in a fluid-tight manner. Electrode support device 10 preferably includes at least one fluid space closure element 51. Fluid space closure element 51 is designed, in particular, as a metal sheet. Fluid space closure element 51 is situated, in particular, on base body 46, in particular on an outside of base body 46 that faces away from electrode installation surface 16. Fluid space closure element 51 and the base body preferably form a fluid space 53 for distributing a fluid, in particular an oxidant and/or a fuel, on fluid channel 48 and/or on further fluid channels.

FIG. 2 shows a detailed view of electrode support device 10. Electrode support device 10 includes at least one form-fitting unit 18. Form-fitting unit 18 is situated at electrode installation surface 16. Form-fitting unit 18 is provided for fixing electrode unit 12 on electrode installation surface 16. Form-fitting unit 18 preferably includes at least one form-fitting element 20, 22, 24, 26, 28, 30. FIGS. 3 through 6 show a detailed view of form-fitting elements 22, 24, 26, 38, 30. Form-fitting unit 18 includes at least one form-fitting element 20, 22, 24, 26, 28, 30 designed as a microtooth for toothing with electrode unit 12. Form-fitting unit 18 includes a multitude of form-fitting elements 20, 22, 24, 26, 28, 30 designed as microteeth for toothing with electrode unit 12. Form-fitting elements 20, 22, 24, 26, 28, 30 of form-fitting unit 18 are designed as one piece with electrode installation surface 16. Form-fitting elements 20, 22, 24, 26, 28, 30 are, in particular, designed as one piece with base body 46.

Form-fitting unit 18 preferably includes at least trapezoidal form-fitting element 20. Trapezoidal form-fitting element 20 has, in particular, a trapezoidal profile in at least one sectional plane at least essentially perpendicular to electrode installation surface 16. Trapezoidal form-fitting element 20 has, in particular, a rectangular and/or trapezoidal profile in a further sectional plane at least essentially perpendicular to the sectional plane and to electrode installation surface 16. Trapezoidal form-fitting element 20 is designed, in particular, as a truncated cone, a truncated pyramid and/or as a trapezoidal web. Trapezoidal form-fitting element 20 of form-fitting unit 18 includes, in particular, an undercut 36. The longer characteristic trapezoid side forms, in particular, electrode installation surface 16. The shorter characteristic trapezoid side is situated, in particular, facing away from electrode installation surface 16.

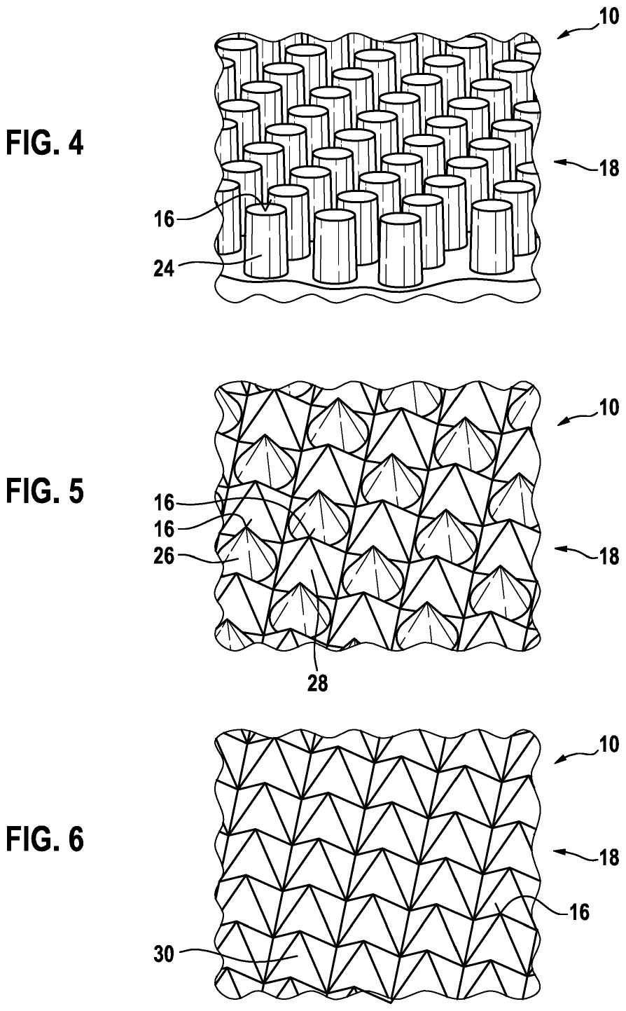

Form-fitting unit 18 preferably includes at least cuboid form-fitting element 22 (see FIG. 3). Form-fitting unit 18 preferably includes at least cylindrical form-fitting element 24 (see FIG. 4). Form-fitting unit 18 preferably includes conical form-fitting element 26 (see FIG. 5). Form-fitting unit 18 preferably includes at least pyramidal form-fitting element 26 (see FIG. 5). Form-fitting unit 18 preferably includes at least further pyramidal form-fitting element 30 (see FIG. 6).

Form-fitting unit 18 preferably includes a multitude of at least essentially identically constructed form-fitting elements. It is possible that form-fitting unit 18 includes form-fitting elements of only one single type. It is also possible that different types of the form-fitting elements are used in different subareas of electrode installation surface 16. Moreover, it is also possible that at least two different types of the form-fitting elements are used, in particular, alternatingly, in at least one subarea (cf. FIG. 5).

At least one of form-fitting elements 20, 22, 24, 26, 28, 30 of form-fitting unit 18 is situated in fluid channel-free subarea 32 of electrode installation surface 16. Form-fitting elements 20, 22, 24, 26, 28, 30 of form-fitting unit 18 are provided, in particular, for sealing off fluid channel area 34, in particular for fixing separating element 44 and/or further electrode 42 on base body 46. Trapezoidal form-fitting element 20, cuboid form-fitting element 22, cylindrical form-fitting element 24, conical form-fitting element 26 and/or pyramidal form-fitting element 28 is/are situated, in particular, in fluid channel-free subarea 32. It is also possible, however, that further pyramidal form-fitting element 30 is situated in fluid channel-free subarea 32. At least one of form-fitting elements 20, 22, 24, 26, 28, 30 of form-fitting unit 18 is situated in fluid channel area 34 of electrode installation surface 16. Further pyramidal form-fitting element 30, in particular, is situated in fluid channel area 34. It is also possible, however, that trapezoidal form-fitting element 20, cuboid form-fitting element 22, cylindrical form-fitting element 24, conical form-fitting element 26 and/or pyramidal form-fitting element 28 is/are situated in fluid channel area 34.

FIG. 7 shows method 38 for manufacturing fuel cell unit and/or electrolyzer unit 14, in particular, a solid oxide fuel cell unit. Fuel cell unit and/or electrolyzer unit 14 includes at least electrode unit 12 and at least electrode support device 10 for supporting electrode unit 12. In at least one method step, electrode unit 12 is connected to electrode support device 10 at least in a form-fitting manner. Method 38 preferably includes an electrode manufacturing step 52. Electrode unit 12 is preferably manufactured in electrode manufacturing step 52. Electrode unit 12 is preferably manufactured, in particular at least preformed, in at least one electrode manufacturing step 52. At least one blank, one preform, one green body, one whiting or the like is preferably manufactured by electrode unit 12 in electrode manufacturing step 52. Electrode unit 12 is preferably manufactured on a transport element 54, in particular, applied in layers.

Method 38 preferably includes at least one electrode support manufacturing step 56. Electrode support device 10 is manufactured preferably in electrode support manufacturing step 56. Electrode support device 10, in particular base body 46, is preferably manufactured at least essentially from titanium, Crofer® 22 H/APU, Inconel® 600 or the like. At least base body 46 of electrode support device 10 is structured preferably during a fluid channel formation step 58. At least one fluid channel 48, in particular, is set into base body 46 in fluid channel formation step 58. The at least one fluid channel 48 is preferably set into base body 46 of electrode support device 10 by a shaping process, in particular, with the aid of punching, imprinting, milling, laser drilling, laser cutting, etching or the like. Electrode support device 10 is preferably deburred in fluid channel formation step 58. Electrode support device 10 is preferably cleaned in fluid channel formation step 58. Electrode installation surface 16 is preferably structured in a texturing step 60 to form form-fitting unit 18. Texturing step 60 may be carried out before, after and/or simultaneously with fluid channel formation step 58. In a texturing step 60, at least one of form-fitting elements 20, 22, 24, 26, 28, 30 of form-fitting unit 18 of electrode support device 10 is formed at electrode installation surface 16 of electrode support device 10, in particular, by a material removal process and/or by a material application process. In a texturing step 60, a dimensioning of at least one of form-fitting elements 20, 22, 24, 26, 28, 30 is adapted to a particle size of electrode unit 12. In a texturing step 60, at least one of form-fitting elements 20, 22, 24, 26, 28, 30 is created with the aid of laser texturing. In texturing step 60, in particular, material is removed from electrode support device 10, in particular from base body 46. In texturing step 60, in particular, material at electrode installation surface 16 is removed. Form-fitting elements 20, 22, 24, 26, 28, 30 are, in particular, formed, in particular, freely cut in texturing step 60. Electrode support device 10 is preferably thermally post-treated in electrode support manufacturing step 56. Electrode support device 10 is preferably rolled up and/or stacked in electrode support manufacturing step 56 for transporting and/or for storing. It is also possible that electrode support device 10 is conveyed directly for further processing, for example, via a conveyor system.

In at least one joining step 62, in particular, pre-formed electrode unit 12 is preferably applied on electrode support device 10, in particular on electrode installation surface 16. In joining step 62, transport element 54 is preferably situated with electrode unit 12 at electrode support device 10. Electrode unit 12, in particular, is faced toward electrode support device 10, in particular, electrode installation surface 16. Joining step 62 preferably includes a heating process and/or a pressing process, in particular for laminating electrode unit 12 onto electrode support device 10, in particular onto electrode installation surface 16. In joining step 62, one form of electrode unit 12 is adapted to the at least one form-fitting element 20, 22, 24, 26, 28, 30 during an application of electrode unit 12 on electrode support device 10. Pre-formed electrode unit 12 is, in particular, pressed onto form-fitting unit 18 for deforming electrode unit 12. One form of electrode unit 12 is, in particular, deformed in joining step 62 complementary to at least one form-fitting element 20, 22, 24, 26, 28, 30. A granulate and/or a paste, from which electrode unit 12 is constructed, is, in particular, distributed at, around and/or between form-fitting elements 20, 22, 24, 26, 28, 30. After electrode unit 12 is placed on electrode support device 10, the, in particular, water-soluble transport element 54 is removed from electrode unit 12, in particular, with the aid of moistening. Method 38 preferably includes a sintering step 64. Electrode unit 12 is preferably sintered in sintering step 64, in particular, in a state applied on electrode support device 10. Electrode unit 12 is connected to electrode support device 10 in a form-fitting manner no later than after sintering step 64 and/or after at least a curing of pre-formed electrode unit 12. Electrode unit 12, in particular in a state applied on electrode support device 12, is raised in sintering step 64 to a temperature of more than 600° C., preferably more than 800° C., preferably more than 1000° C. Electrode support device 10, together with electrode unit 12, is split in a separating step 66 into individual metal-supported fuel cell units and/or electrolyzer units 14.

1-13. (canceled)

14. An electrode support device for supporting an electrode unit of a fuel cell unit and/or electrolyzer unit, comprising:
at least one electrode installation surface for the electrode unit; and
at least one form-fitting unit situated at the electrode installation surface configured to fix the electrode unit at the electrode installation surface.

15. The electrode support device as recited in claim 14, wherein the electrode support device is for supporting an electrode unit of a solid oxide fuel cell unit.

16. The electrode support device as recited in claim 14, wherein at least one form-fitting element of the form-fitting unit is formed as one piece with the electrode installation surface.

17. The electrode support device as recited in claim 14, wherein at least one form-fitting element of the form-fitting unit is situated in a fluid channel-free subarea of the electrode installation surface.

18. The electrode support device as recited in claim 14, wherein at least one form-fitting element of the form-fitting unit is situated in a fluid channel area of the electrode installation surface.

19. The electrode support device as recited in claim 14, wherein at least one form-fitting element of the form-fitting unit includes an undercut.

20. The electrode support device as recited in claim 14, wherein the form-fitting unit includes at least one form-fitting element configured as a microtooth for toothing with the electrode unit.

21. The electrode support device as recited in claim 14, wherein the form-fitting unit includes a multitude of form-fitting elements configured as microteeth for toothing with the electrode unit.

22. A method for manufacturing a fuel cell unit and/or electrolyzer unit, the fuel cell unit and/or electrolyzer unit including at least one electrode unit and at least one electrode support device, the electrode support device at least one electrode installation surface for the electrode unit, and at least one form-fitting unit situated at the electrode installation surface configured to fix the electrode unit at the electrode installation surface, the method comprising:
connecting the electrode unit with the electrode support device in a form-fitting manner.

23. The method as recited in claim 22, wherein the fuel cell unit and/or electrolyzer unit is a solid oxide fuel cell unit.

24. The method as recited in claim 22, further comprising:
forming at least one form-fitting element of the form-fitting unit at the electrode installation surface of the electrode support device by a material removal process and/or by a material application process.

25. The method as recited in claim 22, further comprising:
adapting a form of the electrode unit to at least one form-fitting element of the form-fitting unit of the electrode support device.

26. The method as recited in claim 22, further comprising:
adapting a dimensioning of at least one form-fitting element of the form-fitting unit of the electrode support device to a particle size of the electrode unit.

27. The method as recited in claim 22, further comprising:
creating at least one form-fitting element of the form-fitting unit of the electrode support device using laser texturing.

28. A fuel cell unit and/or electrolyzer unit including an electrode support device, the electrode support device comprising:
at least one electrode installation surface for the electrode unit; and
at least one form-fitting unit situated at the electrode installation surface configured to fix the electrode unit at the electrode installation surface.
